(19) United States
(12) Patent Application Publication
(10) Pub. No.: US 2010/0251994 A1
(43) Pub. Date: Oct. 7, 2010

(54) Remote control model engine assembly

(76) Inventor: Nai Wen Liu, Taichung City (TW)

Correspondence Address: NAI WEN LIU, 5F.-2, No. 212, Sec. 1, Wunsin Rd., Taichung City, 408, TW

(21) Appl. No.: 12/384,301

(22) Filed: Apr. 3, 2009

(51) Int. Cl. F02B 31/00

(52) U.S. Cl. 123/306

(57) ABSTRACT

An improved remote control model engine assembly includes an engine body, a cylinder and a crane shaft chamber. A piston and a piston link rod are pivotally installed in the cylinder. The crane shaft chamber is horizontally and pivotally coupled to a crane shaft, whose end is connected to the bottom of the piston link rod for performing linking and rotating operations. A passage is concavely disposed at a middle section of the crane shaft corresponding to an air intake opening and penetrated axially through the crane shaft chamber. The passage is pivotally and axially coupled to a vane wheel by coaxial rotation, such that a high-speed operation of the crane shaft produces a powerful guide suction in the passage to suck a mixed petroleum gas into the crane shaft chamber and an internal upper space of the cylinder to enhance the igniting explosion effect and the horse power output.

### BACKGROUND OF THE INVENTION

1. Field of the Invention

The present invention relates to a model engine device, and more particularly to a remote control model engine assembly with an enhanced pressure feature to improve explosions for its operation.

2. Description of the Related Art

With reference to FIG. 5 for a conventional remote control model engine, the engine includes an engine body 1 having a cylinder 2, a crane shaft chamber 3, an air intake opening 4 and an air exhaust opening 5. The cylinder 2 includes a piston 6 and a piston link rod 7 installed therein, and a crane shaft 8 is horizontally and pivotally coupled to the crane shaft chamber 3, and an end of the crane shaft 8 is expanded to from a cam disk 8a, and a camshaft 8b is protruded and connected to a distal surface of the cam disk 8a for connecting and linking the bottom of the piston link rod 7. The crane shaft 8 has a passage 8c disposed on a lateral side of a middle section of the crane shaft 8 and extended towards the axial side, and an end of the passage 8c is penetrated through a distal surface of the cam disk 8a. During the operation, fuel and air are mixed in a carburetor, and the mixed petroleum gas is passed from the oblique air intake opening 4 of the engine body 1 downward through the passage 8c of the crane shaft 8 to the crane shaft chamber 3. Now, the piston link rod 7 between the piston 6 and the crane shaft 8 are linked and lifted up, so that the mixed petroleum gas originally stored in an internal upper space of the cylinder 2 is ignited by a spark plug for producing an explosion, and pressure is produced to push the piston down. While the piston 6 is moving downward, a scavenging opening 2a disposed adjacent to the cylinder 2 is opened, and the mixed petroleum gas originally stored in the crane shaft chamber 3 can be pressed down by the piston 6 and sucked through the scavenging opening 2a and into the internal upper space of the cylinder 2, and the previously produced combustion exhaust gas is discharged from the exhaust hole 5 on another side of the cylinder 2 to complete a cycle of the operation.

In the foregoing operation, the air intake totally relies on the passage 8c to be sucked into the crane shaft chamber 3. Although the crane shaft 8 rotates with the back-and-forth movements of the piston 6, the mixed petroleum gas is entered linearly into the crane shaft chamber 3 since the passage 8c is consisted of linearly arranged circular holes. After the mixed petroleum gas reaches the crane shaft chamber 3 at the bottom of the piston link rod 7, the compression force of the piston 6 pushes the mixed petroleum gas linearly into the internal upper space of the cylinder 2 before the combustion takes place. Therefore, the effect of naturally supplying the mixed petroleum gas can be maintained at a low level only, but it cannot be enhanced. Once if the engine is operated at a high speed, the igniting explosion effect produced by the mixed petroleum gas in the cylinder 2 usually cannot achieve the expected horse power output.

### SUMMARY OF THE INVENTION

It is a primary objective of the present invention to provide an improved remote control model engine assembly that produces a powerful suction to suck a mixed petroleum gas into a crane shaft chamber and an internal upper space of a cylinder during a high-speed operation of a crane shaft, so as to enhance the igniting explosion effect and the horse power output effectively.

To achieve the foregoing objective, the present invention provides an improved remote control model engine assembly comprising: an engine body, having an air intake opening disposed individually on two isolated external sides for coupling and interconnecting a carburetor and an air exhaust opening for discharging an exhaust gas to the outside, and including a cylinder and a crane shaft chamber installed therein and interconnected with each other, and the cylinder including a piston and a piston link rod movably installed in the cylinder, and a crane shaft being installed horizontally to the crane shaft chamber, and an end of the crane shaft being expanded to form a cam disk, and a camshaft connected to a distal surface of the cam disk for connecting the bottom of the piston link rod to perform a linking operation, and a middle section of the crane shaft being disposed opposite to the air intake opening and having a passage extended axially, and an end of the passage penetrating a distal surface of the cam disk, such that a mixed petroleum gas of the carburetor is interconnected to the crane shaft chamber and guided into an internal upper space of the cylinder for igniting explosion and combustion; characterized in that: a vane wheel is pivotally and axially installed at the passage of the crane shaft by a coaxial rotation method, such that the high-speed operation of the crane shaft produces a powerful guide suction at the passage to suck the mixed petroleum gas into the crane shaft chamber and an internal upper space of the cylinder, so as to enhance an igniting explosion effect and a horse power output.

### BRIEF DESCRIPTION OF THE DRAWINGS

FIG. 1 is a cross-sectional view of a remote control model engine in accordance with a preferred embodiment of the present invention;

FIG. 2 is a perspective view of a remote control model engine in accordance with a preferred embodiment of the present invention;

FIG. 3 is a perspective view of a crane shaft and a vane wheel assembled in accordance with a preferred embodiment of the present invention;

FIG. 4 is a schematic view of an operation of a remote control model engine in accordance with a preferred embodiment the present invention; and

FIG. 5 is a schematic view of an operation of a conventional remote control model engine.

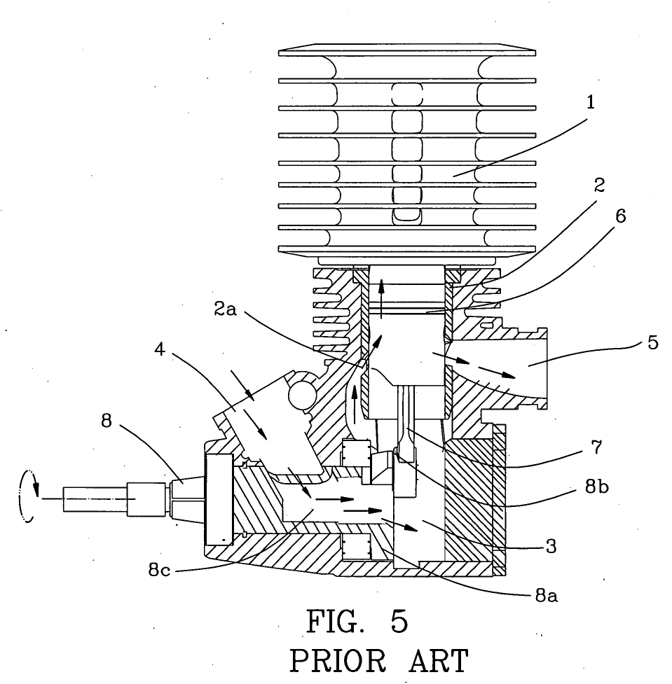

### DETAILED DESCRIPTION OF THE PREFERRED EMBODIMENTS

To make it easier for our examiner to understand the objects, effects and advantages of the present invention, we use preferred embodiments with related drawings for the detailed description of the present invention as follows.

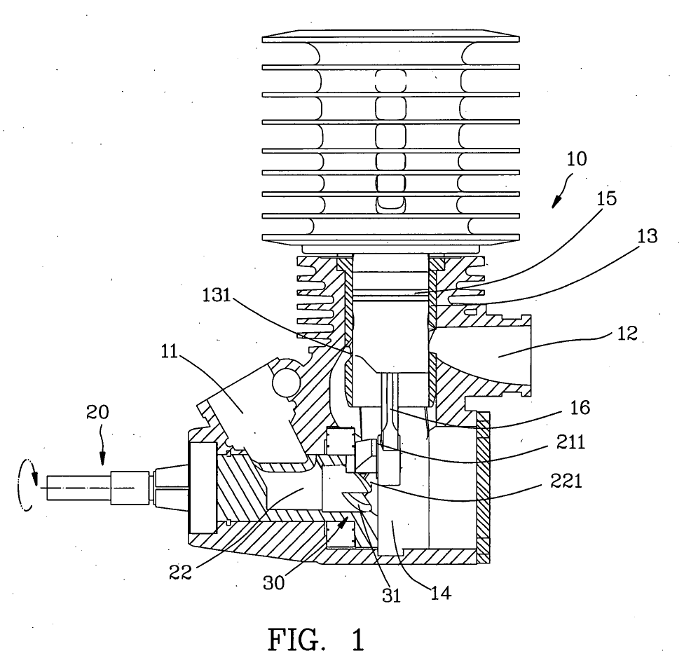

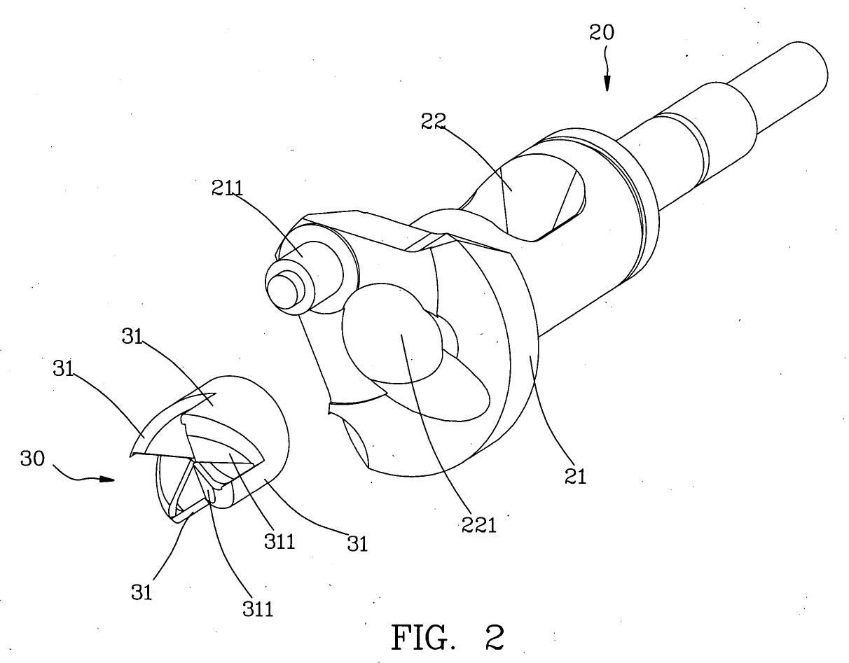

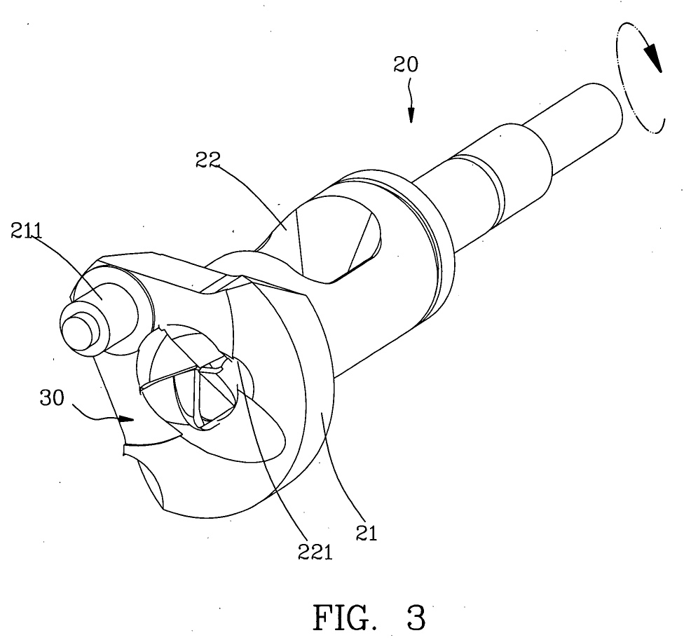

With reference to FIGS. 1 to 4 for an improved remote control model engine assembly of the present invention, the engine comprises an engine body 10, a crane shaft 20 and a vane wheel 30.

An air intake opening 11 is disposed individually on two external isolated sides of the engine body 10 for coupling and interconnecting a carburetor and discharging a combustion exhaust gas to the outside, and an air exhaust opening 12 is provided for interconnecting a cylinder 13 and a crane shaft chamber 14 therein, and a piston 15 and a piston link rod 16 are movably installed in the cylinder 13.

The crane shaft 20 is a rod horizontally installed in the crane shaft chamber 14 of the engine body 10, and an end of the crane shaft 20 is expanded to form a cam disk 21, and a camshaft 211 is coupled to a distal surface of the cam disk 21 to connect the bottom of the piston link rod 16 for a linking operation, and a passage 22 is disposed on a lateral side of a middle section corresponding to the air intake opening 11 and extended towards the axial side. An end of the passage 22 is penetrated through a hole 221 at a distal surface of the cam disk 21 for interconnecting a mixed petroleum gas in the carburetor with the crane shaft chamber 14 and guiding the mixed petroleum gas into an internal upper space of the cylinder 13 for igniting explosion and combustion.

The vane wheel 30 is fixed axially to the passage 22 of the crane shaft 20 by a coaxial rotation method, and at least one guide vane 31 is installed at a lateral side of the vane wheel 30. In this embodiment, there are four guide vanes 31, such that the high-speed operation of the guide vanes 31 together with the crane shaft 20 produces a powerful guide suction in the passage 22 to suck a mixed petroleum gas into the crane shaft chamber 14 and an internal upper space of the cylinder 13, so as to enhance the igniting explosion effect and the horse power output, wherein an oblique guide surface 311 is convexly disposed on a distal surface of each guide vane 31 for naturally producing and accelerating swirls to enhance the air intake of the engine during the air intake process.

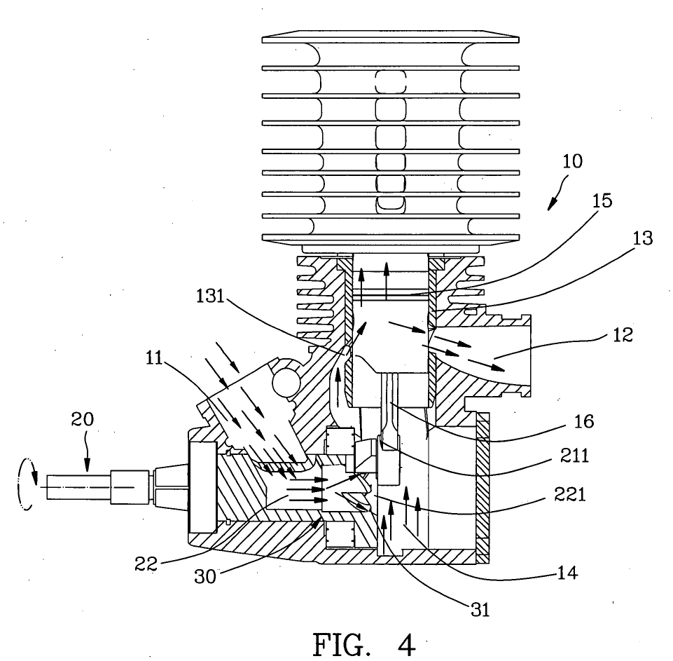

The improved remote control model engine assembly of the present invention is formed by assembling the aforementioned components. When the engine is operated as illustrated in FIG. 4, a mixed petroleum gas will pass from the oblique air intake opening 11 of the engine body 10 downward through the passage 22 of the crane shaft 20 to the crane shaft chamber 14 at the bottom of the piston link rod 16. Now, the piston link rod 16 drives the piston 15 and the crane shaft 20 to be lifted, and then the original mixed petroleum gas at the internal upper space of the cylinder 13 is ignited to produce an explosion, such that a pressure is produced to push the piston 15 to move downward. While the piston 15 is moving downward, a scavenging opening 131 disposed next to the cylinder 13 is opened, such that the mixed petroleum gas originally stored in the crane shaft 20 can be pressed by the piston 15 and sucked through the scavenging opening 131 and into the internal upper space of the cylinder 13 for igniting explosion and combustion, and the produced exhaust gas can be discharged from the air exhaust opening 12 on the other side of the cylinder 13. The aforementioned operation is performed repeatedly.

In the operation, the vane wheel 30 and the crane shaft 20 are rotated coaxially. Together with the high-speed operation of the crane shaft 20, four guide vanes 31 installed at the distal edges of the vane wheel 30 produce a powerful guide suction in the passage 22 to suck the mixed petroleum gas into the crane shaft chamber 14 and an internal upper space of the cylinder 13, so as to enhance the igniting explosion effect and the horse power output. Particularly, the design of the oblique guide surface 311 at the distal surface-of each guide vane 31 can accelerate the air entering linearly into the passage 22 to produce a suction swirl effect. The suction pressure can enhance the air intake of the engine, such that when the engine of the present invention is operated at a higher speed, the suction swirl effect can enhance the pressure, and the mixed petroleum gas at the top of the cylinder 13 can have a better igniting explosion effect, so as to achieve the expected horse power output.

What is claimed is:

1. An improved remote control model engine assembly, comprising an engine body having an air intake opening disposed individually on two isolated external sides for coupling and interconnecting a carburetor and an air exhaust opening for discharging an exhaust gas to the outside, and including a cylinder and a crane shaft chamber installed therein and interconnected with each other, and the cylinder including a piston and a piston link rod movably installed in the cylinder, and a crane shaft being installed horizontally to the crane shaft chamber, and an end of the crane shaft being expanded to form a cam disk, and a camshaft connected to a distal surface of the cam disk for connecting the bottom of the piston link rod to perform a linking operation, and a middle section of the crane shaft being disposed opposite to the air intake opening and having a passage extended axially, and an end of the passage penetrating a distal surface of the cam disk, such that a mixed petroleum gas of the carburetor is interconnected to the crane shaft chamber and guided into an internal upper space of the cylinder for igniting explosion and combustion; characterized in that a vane wheel is pivotally and axially installed at the passage of the crane shaft by a coaxial rotation method, such that the high-speed operation of the crane shaft produces a powerful guide suction in the passage to suck the mixed petroleum gas into the crane shaft chamber and an internal upper space of the cylinder, so as to enhance an igniting explosion effect and a horse power output.

2. The improved remote control model engine assembly of claim 1, wherein the vane wheel includes at least one guide vane installed at a distal side of the vane wheel.

3. The improved remote control model engine assembly of claim 1, wherein the vane wheel includes at least one guide vane disposed at a distal side of the vane wheel, and the guide vane includes an oblique guide surface protruded from a distal surface of the guide vane.
